(19) United States
(12) Patent Application Publication
(10) Pub. No.: US 2021/0040007 A1
(43) Pub. Date: Feb. 11, 2021

(54) AMINO ACID & NUTRIENT FORMULATION FOR STRESS MITIGATION IN PLANTS

(71) Applicant: Compass Minerals USA Inc., Overland Park, KS (US)

(72) Inventors: Andres Reyes Gaige, Overland Park, KS (US); Ithamar Prada, São Paulo (BR); Renil John Anthony, Lenexa, KS (US)

(21) Appl. No.: 16/935,924

(22) Filed: Jul. 22, 2020

Related U.S. Application Data
(60) Provisional application No. 62/877,116, filed on Jul. 22, 2019.

(51) Int. Cl. C05G 1/00; C05D 9/02; C05F 11/10; C05D 5/00; C05G 5/23; C05G 5/27; A01C 21/00

(52) U.S. Cl. CPC C05G 1/00; C05D 9/02; C05F 11/10; A01C 21/007; C05G 5/23; C05G 5/27; C05D 5/00

(57) ABSTRACT

The present disclosure provides a new amino acid and nutrient composition for use as a stress mitigator in plants. The composition comprises at least cobalt, nickel, zinc, and phosphorus, and in some embodiments comprises additional nutrients and/or amino acids. The composition is preferably provided in liquid form and can be used as a foliar treatment. Advantageously, these compositions assist the plants in achieving higher biomass and chlorophyll levels and appropriate gene expression, similar to that of the plant when the stress conditions are not present.

### RELATED APPLICATIONS

The present application claims the priority benefit of U.S. Provisional Patent Application Ser. No. 62/877,116, filed Jul. 22, 2019, entitled AMINO ACID & NUTRIENT FORMULATION FOR STRESS MITIGATION IN PLANTS, incorporated by reference in its entirety herein.

### SEQUENCE LISTING

The following application contains a sequence listing in computer readable format (CRF), submitted as a text file in ASCII format entitled “Sequence_Listing,” created on Oct. 14, 2020, as 4 KB. The content of the CRF is hereby incorporated by reference.

### BACKGROUND

### Field

The present disclosure broadly relates to novel amino acid and nutrient formulations and a method of using those formulations to assist in mitigating plant stress that leads to changes in the physiological, morphological, ecological, biochemical and/or molecular traits of the plant.

### Description of Related Art

Drought stress occurs when plants fail to receive adequate water, reducing plant water content enough to interfere with normal plant processes such as photosynthesis, which results in reduced leaf size, root health, and/or stem size. This can substantially interfere with crop production, reducing plant quality and yield. There is a need for treatments that mitigate a plant's response to drought and other stress conditions so as to enable normal or near-normal plant processes to be carried out when such conditions are encountered.

### SUMMARY

In one embodiment, the disclosure is concerned with a nutrient composition comprising L-glutamic acid and respective sources of each of cobalt, nickel, zinc, and phosphorus.

In another embodiment, the disclosure provides a method of using a nutrient composition comprising contacting the nutrient composition with a plant and/or soil in which the plant is planted or will be planted. The nutrient composition preferably comprises L-glutamic acid and respective sources of each of cobalt, nickel, zinc, and phosphorus.

In a further embodiment, the disclosure provides a plant with a nutrient composition in contact with the plant. The nutrient composition preferably comprises L-glutamic acid and respective sources of each of cobalt, nickel, zinc, and phosphorus.

In yet a further embodiment, the disclosure provides the combination of soil and a nutrient composition. The nutrient composition preferably comprises L-glutamic acid and respective sources of each of cobalt, nickel, zinc, and phosphorus.

### BRIEF DESCRIPTION OF THE DRAWINGS

FIG. 1 is a graph comparing chlorophyll levels of corn plants under drought stress when treated according to one embodiment of the present disclosure to comparative and control corn plants as described in Example 2;

FIG. 2 is another graph comparing chlorophyll levels of a different round of corn plants under drought stress when treated according to one embodiment of the present disclosure to comparative and control corn plants as described in Example 2;

FIG. 3 is a graph comparing chlorophyll levels of soybean plants under drought stress when treated according to one embodiment of the present disclosure to comparative and control soybean plants as described in Example 2;

FIG. 4 is another graph comparing chlorophyll levels of a different round of soybean plants under drought stress when treated according to one embodiment of the present disclosure to comparative and control soybean plants as described in Example 2;

FIG. 5 is a graph comparing the dry biomass of corn plants under drought stress when treated according to one embodiment of the present disclosure to comparative and control corn plants as described in Example 3;

FIG. 6 is another graph comparing the dry biomass of a different round of corn plants under drought stress when treated according to one embodiment of the present disclosure to comparative and control corn plants as described in Example 3;

FIG. 7 is a graph comparing the dry biomass of soybean plants under drought stress when treated according to one embodiment of the present disclosure to comparative and control soybean plants as described in Example 3;

FIG. 8 is another graph comparing the dry biomass of a different round of soybean plants under drought stress when treated according to one embodiment of the present disclosure to comparative and control soybean plants as described in Example 3;

FIG. 9 is a bar graph comparing the gene expression of corn plants under drought stress when treated according to one embodiment of the present disclosure to comparative and control corn plants as described in Example 4;

FIG. 10 is another bar graph comparing the gene expression of a different round of corn plants under drought stress when treated according to one embodiment of the present disclosure to comparative and control corn plants as described in Example 4;

FIG. 11 is a bar graph comparing the gene expression of soybean plants under drought stress when treated according to one embodiment of the present disclosure to comparative and control soybean plants as described in Example 4;

FIG. 12 is another bar graph comparing the gene expression of a different round of soybean plants under drought stress when treated according to one embodiment of the present disclosure to comparative and control soybean plants as described in Example 4;

FIG. 13 is photograph comparing corn (top) and soybean (bottom) plants grown under drought stress when treated according to present disclosure to comparative and control plants as described in Example 5;

FIG. 14 is a bar graph comparing the gene expression of corn plants under drought stress when treated according to the present disclosure to comparative and control corn plants as described in Example 5;

FIG. 15 is a bar graph comparing the gene expression of corn plants under drought stress when treated according to the present disclosure to comparative and control corn plants as described in Example 5;

FIG. 16 is a bar graph comparing the gene expression of soybean plants under drought stress when treated according to the present disclosure to comparative and control soybean plants as described in Example 5; and

FIG. 17 is a bar graph comparing the gene expression of soybean plants under drought stress when treated according to the present disclosure to comparative and control soybean plants as described in Example 5.

### DETAILED DESCRIPTION

Embodiments of the present disclosure are concerned with stress mitigation compositions, and particularly stress mitigation formulations that are suitable for foliar applications. The compositions generally comprise at least one nutrient and at least one amino acid, but more preferably comprise two or more nutrients and two or more amino acids.

### 1. Nutrients

The source of at least one nutrient is generally provided as a solid powder. As used herein, the term “nutrient” refers to both micronutrients and macronutrients. The source of at least one nutrient may comprise one or more macronutrients, one or more micronutrients, or a combination of both macronutrients and micronutrients. Macronutrients are essential plant nutrients that are required in relatively larger amounts (as compared to micronutrients) for healthy plant growth and development. In contrast, micronutrients are essential plant nutrients that are needed in lesser quantities. In certain embodiments, the source of at least one nutrient comprises a macronutrient selected from the group consisting of nitrogen, phosphorus, potassium, calcium, sulfur, and magnesium. In certain embodiments, the source of at least one nutrient comprises a micronutrient selected from the group consisting of zinc, manganese, iron, boron, chlorine, copper, molybdenum, nickel, cobalt, selenium, and sodium. It should be understood by those of skill in the art that other macronutrients and micronutrients known in the art may also be used in accordance with embodiments of the present disclosure.

Preferred nutrient sources include those selected from the group consisting of sulfates, oxides, chlorides, carbonates, phosphates, nitrates, and chelates of the nutrient. In the instance of chelated sources, the chelating agent is preferably selected from the group consisting of ethylenediaminetetraacetic acid (“EDTA acid”), ethylene diaminetetraacetate (“EDTA”), EDTA salts, and mixtures thereof, and preferably a salt of EDTA. Particularly preferred chelating agents are selected from the group consisting of ammonium salts of EDTA or EDTA acid (preferably a monoammonium or diammonium salt) and metal salts of EDTA or of EDTA acid. Preferred metal salts are dimetal or tetrametal salts, while preferred metals of these salts are selected from the group consisting of Group I and Group II metals. The most preferred Group I and Group II metals are selected from the group consisting of sodium (e.g., disodium, tetrasodium), lithium, calcium, potassium, and magnesium.

In particularly preferred embodiments, the nutrient source comprises respective sources of cobalt, nickel, zinc, and phosphorus. The cobalt source is preferably selected from the group consisting of chelated cobalt, cobalt sulfate, and mixtures thereof.

The nickel source is preferably selected from the group consisting of chelated nickel, nickel oxide, nickel sulfates, nickel chloride, and mixtures thereof.

Preferred sources of zinc include those selected from the group consisting of chelated zinc, zinc oxide, zinc sulfates (e.g., zinc sulfate monohydrate), zinc hydroxide carbonate, zinc chloride, and mixtures thereof.

The phosphorus source is preferably selected from the group consisting of monoammonium phosphate, diammonium phosphate, monopotassium phosphate, rock phosphate, and mixtures thereof.

In one embodiment, the composition includes no nutrients other than cobalt, nickel, zinc, and phosphorus. In another embodiment, however, the composition not only comprises respective sources of cobalt, nickel, zinc, and phosphorus, but it further comprises respective sources of one or both of molybdenum and magnesium. In yet a further embodiment, the composition includes no nutrients other than cobalt, nickel, zinc, phosphorus, molybdenum, and magnesium.

Regardless of the embodiment, the molybdenum source is preferably selected from the group consisting of sodium molybdate (preferably dihydrate), ammonium heptamolybdate, potassium molybdate, ammonium molybdate tetrahydrate, chelated molybdenum, and mixtures thereof, and the magnesium source is preferably selected from the group consisting of magnesium sulfate, magnesium oxide, sulphate of potash magnesia, and mixtures thereof.

Table A sets forth preferred nutrient quantities. It will be appreciated that these quantities refer to the nutrient itself and not to the quantity of the source of the nutrient. One skilled in the art will understand how to determine the appropriate quantity of the nutrient source (which is dependent upon the particular nutrient source being utilized) for delivering the particular nutrient within these levels.

TABLE A

| | BROADEST | | MOST |
|---|---|---|---|
| INGREDIENT | RANGE** | PREFERRED** | PREFERRED** |
| Cobalt | about 0.05% to | about 0.1% to | about 0.15% to |
| | about 3% | about 1.5% | about 0.35% |
| Nickel | about 0.1% to | about 0.2% to | about 0.5% to |
| | about 3% | about 1.5% | about 1% |
| Zinc | about 0.5% to | about 1% to | about 2% to |
| | about 8% | about 6% | about 4% |
| Phosphorus | about 2.5% to | about 2.8% to | about 3% to |
| | about 8% | about 6% | about 5% |
| Molybdenum* | about 1% to | about 2% to | about 4% to |
| | about 10% | about 8% | about 6% |
| Magnesium* | about 0.1% to | about 0.2% to | about 0.3% to |
| | about 5% | about 2% | about 0.7% |
| Manganese* | about 0.01% to | about 0.05% to | about 0.1% to |
| | about 5% | about 1% | about 0.5% |
| Iron* | about 0.01% to | about 0.05% to | about 0.1% to |
| | about 6% | about 4% | about 2% |
| Boron* | about 0.0001% | about 0.001% | about 0.01% to |
| | to about 5% | to about 2% | about 1% |
| Calcium* | about 0.1% to | about 0.5% to | about 1% to |
| | about 12% | about 8% | about 5% |
| Sulfur* | about 0.05% to | about 0.1% to | about 0.5% to |
| | about 8% | about 2% | about 0.8% |
| Potassium* | about 1.5% to | about 1.5% to | about 1.5% to |
| | about 8% | about 5% | about 2.5% |
| Nitrogen* | about 0.1% to | about 1% to | about 1.5% to |
| | about 15% | about 10% | about 3.5% |

*In embodiments where this ingredient is present (i.e., when it is not 0%).
**All ranges are % by weight, based upon the total weight of the composition taken as 100% by weight.

### 2. Amino Acids

As noted above, the disclosed compositions comprise at least one amino acid. Preferred amino acids include L-glutamic acid, tryptophan, aspartic acid, serine, glycine, alanine, valine, methionine, isoleucine, leucine, phenylalanine, lysine, and mixtures of the foregoing.

In a preferred embodiment, the amino acid present in the composition is L-glutamic acid. Preferably, L-glutamic acid comprises at least about 75% by weight, preferably from about 75% by weight to about 99% by weight, and even more preferably from about 85% by weight to about 95% by weight of the total amino acids present in the composition, based upon the total weight of all amino acids taken by 100% by weight.

In a further embodiment, the composition includes both L-glutamic acid and tryptophan. In this embodiment, the L-glutamic acid quantities are as set forth above while tryptophan preferably comprises at least about 0.35% by weight, preferably from about 0.35% by weight to about 1% by weight, and even more preferably from about 0.4% by weight to about 0.6% by weight of the total amino acids present in the composition, based upon the total weight of all amino acids taken by 100% by weight.

In yet a further embodiment of the disclosure, the composition includes L-glutamic acid and tryptophan as well as aspartic acid, serine, glycine, alanine, valine, methionine, isoleucine, leucine, phenylalanine, and lysine. Table B sets forth preferred individual amino acid quantities in the compositions according to the disclosure.

TABLE B

| | BROADEST | | MOST |
|---|---|---|---|
| INGREDIENT | RANGE** | PREFERRED** | PREFERRED** |
| L-Glutamic | about 0.1% to | about 0.5% to | about 1% to |
| Acid | about 10% | about 5% | about 3% |
| Tryptophan* | about 0.01% to | about 0.01% to | about 0.02% to |
| | about 0.5% | about 0.1% | about 0.05% |
| Aspartic | about 0.0001% | about 0.005% | about 0.01% to |
| Acid* | to about 5% | to about 1% | about 0.1% |
| Serine* | about 0.0001% | about 0.001% | about 0.005% |
| | to about 5% | to about 1% | to about 0.1% |
| Glycine* | about 0.0001% | about 0.0005% | about 0.001% |
| | to about 5% | to about 1% | to about 0.1% |
| Alanine* | about 0.0001% | about 0.0005% | about 0.001% |
| | to about 5% | to about 1% | to about 0.1% |
| Valine* | about 0.0001% | about 0.0005% | about 0.001% |
| | to about 5% | to about 1% | to about 0.1% |
| Methionine* | about 0.0001% | about 0.005% | about 0.01% to |
| | to about 5% | to about 1% | about 0.1% |
| Isoleucine* | about 0.0001% | about 0.0005% | about 0.001% |
| | to about 5% | to about 1% | to about 0.1% |
| Leucine* | about 0.0001% | about 0.0005% | about 0.001% |
| | to about 5% | to about 1% | to about 0.1% |
| Phenylalanine* | about 0.0001% | about 0.001% | about 0.1% to |
| | to about 5% | to about 1% | about 0.3% |
| Lysine* | about 0.00005% | about 0.0001% | about 0.0005% |
| | to about 5% | to about 3% | to about 1% |

*In embodiments where this ingredient is present (i.e., when it is not 0%).
**All ranges are % by weight, based upon the total weight of the composition taken as 100% by weight.

### 3. Additional Ingredients

Stevioside is one ingredient that can be present in some embodiments of the disclosed compositions. In one preferred embodiment containing stevioside, the composition comprises at least cobalt, nickel, zinc, and phosphorus in combination with L-glutamic acid, where the L-glutamic acid is present, either with or without other amino acids. Further, this preferred embodiment may further include tryptophan as one of the amino acids, along with L-glutamic acid.

In embodiments were stevioside is included, it is preferably present at levels of from about 0.01% to about 1% by weight, more preferably from about 0.01% to about 0.5% by weight, and even more preferably from about 0.06% to about 0.1% by weight, based upon the total weight of the composition taken as 100% by weight.

A number of optional ingredients can be included in the disclosed compositions. Suitable optional ingredients include those selected from the group consisting of rheology additives, biocides, defoamers, sugars (e.g., glucose, maltose), organic acids (e.g., acetic acid, citric acid, lactic acid), dispersing agents (e.g., sodium salt of naphthalene sulfonate condensate, zeolite, talc, graphite), and mixtures of the foregoing.

In embodiments where a thickening agent is added, the thickening agent acts as a rheology modifying additive designed to hydrate in water and swell. The thickening agent can be any of a variety of rheology modifying compounds, both natural (e.g., clays and gums) and synthetic (e.g., synthetic polymers). In certain embodiments, the fertilizer composition comprises a thickener selected from the group consisting of xanthan gum, guar gum, gum Arabic, smectite, kaolinite, alkali swellable emulsion (ASE) thickeners, hydrophobically modified alkali swellable emulsion (HASE) thickeners, hydrophobically ethoxylated urethane (HEUR) thickeners, and combinations thereof. In some embodiments, the composition comprises a combination of at least two of the aforementioned thickeners. In one embodiment, the thickener comprises xanthan gum. In embodiments where a thickening agent is included, the composition comprises from about 0.01% by weight to about 1% by weight, preferably from about 0.05% by weight to about 0.5% by weight, and more preferably from about 0.1% to about 0.2% by weight of the thickening, based upon the total weight of the composition taken as 100% by weight.

In embodiments where an antimicrobial preservative (e.g., a biocide) is included, preferred such compounds include those selected from the group consisting of 5-chloro-2-methyl-2H-isothiazol-3-one, 2-methyl-2H-isothiazol-3-one, bronopol (2-bromo-2-nitropropane-1,3-diol), sodium nitrite, 1,2-benzisothiazolin-3-one, glutaraldehyde, sodium o-phenylphenate, 2,2-dibromo-3-nitrilopropionamide, sodium hypochlorite, trisodium phosphate, and combinations thereof. In a particularly preferred embodiment, the preservative comprises a combination of 5-5chloro-2-methyl-2H-isothiazol-3-one, 2-methyl-2H-isothiazol-3-one, and bronopol. The use of an antimicrobial preservative is advantageous for limiting growth of bacteria or fungus in the formulation, thus maintaining stability and preventing spoilage of the formulation during long-term storage without negatively impacting seed germination. In embodiments where an antimicrobial is included, the liquid fertilizer composition comprises from about 0.01% by weight to about 1% by weight, preferably from about 0.05% by weight to about 0.5% by weight, and more preferably from about 0.1% by weight to about 0.2% by weight, based on the total weight of the liquid fertilizer composition taken as 100% by weight.

In some a defoamer additive (i.e., anti-foaming agent) can be added to reduce and/or hinder the foaming during production and use of the liquid fertilizer composition. The defoamer may comprise a variety of compounds known in the art to perform this function, including those selected from the group consisting of insoluble oils, silicones (e.g., polydimethylsiloxanes), alcohols, stearates, glycols, and combinations thereof. In certain embodiments, the liquid fertilizer composition comprises from about 0.01% by weight to about 1% by weight, preferably from about 0.05% by weight to about 0.5% by weight, and more preferably from about 0.1% by weight to about 0.2% by weight of the defoamer, based upon the total weight of the liquid fertilizer composition taken as 100% by weight.

### 3. Method of Making the Compositions

Compositions according to the disclosure are preferably formed by simply mixing the foregoing ingredients with water under ambient conditions until a substantially uniform solution or dispersion is obtained. When forming the composition, water will typically be present at levels of from about 5% by weight to about 95% by weight, preferably from about 20% by weight to about 80% by weight, and more preferably from about 25% by weight to about 40% by weight, based upon the total weight of the composition taken as 100% by weight. This water level can be maintained at time of administration of the disclosed composition; however, it is preferable to dilute the composition at the time of administration. Typical dilution levels involve diluting the foregoing composition in water at a level of from about 1% by weight to about 10% by weight in water, preferably from about 1% by weight to about 5% by weight in water, and more preferably from about 1.5% by weight to about 3% by weight in water.

### 4. Method of Using the Compositions

The method of use involves introducing the composition (preferably diluted, as described above) into an environment where plant stress is of concern. The stress can be any type that leads to changes in the physiological, morphological, ecological, biochemical, and/or molecular traits of the plant, with drought being a particularly problematic plant stress that can be treated according to the disclosure.

The introduction of the composition to the plant typically involves contacting the product according to this disclosure with the plant, and particularly the leaves, but it can also involve contact with soil or a mixture of sand and soil in which the plant is or will be growing or any other media where the plant is being grown. Typically, treatment will be commenced once the stress condition (e.g., drought) is observed. Advantageously, after one application the plants typically show improvement, but if the stress continues, treatment can be carried out again. It is also possible to apply the treatment composition in anticipation of a stress condition, as a preventative measure.

Regardless, the disclosed treatment composition is generally applied to the plant and/or soil at a rate of from about 1 liter of composition per hectare of soil to about 4 liters of composition per hectare of soil, preferably from about 1 liter of composition per hectare of soil to about 3 liters of composition per hectare of soil and more preferably from about 1.5 liters of composition per hectare of soil to about 2.5 liters of composition per hectare of soil. The rate can vary depending on the severity of the stress condition, crop, growth stage, and/or soil pH.

The treatment compositions can be utilized with a wide variety of plants, including those selected from the group consisting of corn, soybeans, rice, wheat, potato, sweet potato, citrus, common beans, tomato, and other horticultural crops.

It will be appreciated that a number of advantages are achieved by the present disclosure. For example, plants treated according to the disclosure are able to synthesize more chlorophyll than a plant grown under the same conditions except without the use of the disclosed treatment composition. When a plant is exposed to a stress (e.g., drought) during growing and that plant is treated with a formulation of the disclosure, at about 4 weeks of growth that plant will have a chlorophyll content that is at least about 1.5 times, preferably at least about 1.7 times, and more preferably at least about 1.9 times the chlorophyll content of the same type of plant after the same weeks of growth, also exposed to that stress, and grown under the same conditions but without receiving the herein described treatment. Chlorophyll levels are determined as described in Example 2. When the plant being treated with the disclosed composition is soybeans, the chlorophyll difference will preferably be at least about 1.6 times, more preferably at least about 1.7 times, and even more preferably at least about 2.2 times, where ranges such as 0-5 times, 1-5 times, 1-3 times, and 1-2.5 times are envisioned. When the plant being treated with the composition is corn and growth is for 8 weeks, the chlorophyll difference will preferably be at least about 2.2 times.

Additionally, when a plant is exposed to a stress during growing and that plant is treated with a formulation of the disclosure, at about two months of growth that plant will have a chlorophyll content that is at least about 1.05 times, and preferably at least about 1.1 times the chlorophyll content of the same type of plant after the two months of growth, also exposed to that stress, and grown under the same conditions but without receiving the herein described treatment. (An upper limit of about 10 times can be used with any of the foregoing chlorophyll synthesis ranges.)

Plants treated according to the present disclosure are able to retain a large portion of the chlorophyll synthesis ability as the same type of plant grown without exposure to the stress. For example, when a plant is exposed to a stress during growing and that plant is treated with a formulation of the disclosure, at about 4 weeks of growth that plant will have a chlorophyll content that is at least about 60%, preferably at least about 70%, more preferably at least about 75%, and even more preferably at least about 80% of the chlorophyll content of the same type of plant after the same weeks of growth under the same conditions but without exposure to the stress and without the treatment according to this disclosure.

When that plant is corn, this chlorophyll retention will be at least about 75%, preferably at least about 80%, more preferably at least about 90%, even more preferably at least about 95%, and most preferably at least about 100%. When that plant is corn and growth is for about 8 weeks or about 2 months, this chlorophyll retention will be at least about 75%, preferably at least about 90%, more preferably at least about 105% and even more preferably at least about 110%.

When that plant is a soybean plant, this chlorophyll retention will be at least about 75%, and preferably at least about 85%. When that plant is a soybean plant that is grown for about 8 weeks or about 2 months, this chlorophyll retention will be at least about 85%, and more preferably at least about 95%. (An upper limit of about 100% or about 125% can be used with any of the foregoing chlorophyll retention ranges.)

A further advantage of the present disclosure is that plants treated according to the present disclosure are able to achieve greater dry biomasses than a plant grown under the same conditions except without the use of the disclosed treatment composition. When a plant is exposed to a stress (e.g., drought) during growing and that plant is treated with a formulation of the present disclosure, at about 4 weeks of growth that plant will have a dry biomass that is at least about 1.5 times, preferably at least about 1.7 times, more preferably at least about 1.9 times, and even more preferably at least about 2.3 times the dry biomass of the same type of plant after the same weeks of growth, also exposed to the stress, and grown under the same conditions but without the disclosed treatment. Dry biomass is determined as described in Example 3. When that plant is soybeans, the dry biomass difference will be at least about 1.5 times, preferably at least about 1.7 times, more preferably be at least about 2.5 times, and even more preferably at least about 2.9 times. When that plant is corn, the dry biomass difference will be at least about 1.6 times, preferably at least about 1.8 times, and even more preferably at least about 2.4 times. At about 8 weeks or 2 months of growth, that dry biomass difference will be at least about 1.3 times and preferably at least about 1.4 times. (An upper limit of about 5 times or about 10 times can be used with any of the foregoing biomass achieved ranges.)

Plants treated according to the present disclosure are able to retain a large portion of the dry biomass as the same type of plant grown without exposure to the stress. When a plant is exposed to a stress during growing and that plant is treated with a formulation of the disclosure, at about 4 weeks of growth that plant will have a dry biomass that is at least about 55%, preferably at least about 60%, preferably at least about 70%, and more preferably at least about 80% of the dry biomass of the same type of plant after the same weeks of growth under the same conditions but without exposure to the stress and without the treatment according to this disclosure. At about 8 weeks or 2 months of growth, that dry biomass retention will be at least about 65% and preferably at least about 75%. (An upper limit of about 100% can be used with any of the foregoing biomass retention ranges.)

Yet a further advantage of the present disclosure is that it allows plants to keep the expression of certain genes related and/or affected by plant stress at or close to normal levels, even during stress, and better than the same plant type exposed under the same conditions but without receiving the described treatment. For example, when corn is exposed to a stress (e.g., drought) during growing and that corn is treated with a formulation of the present disclosure, about 24 hours after treatment that corn's expression of phosphoglycerate mutase is at least about 1.2 times, preferably at least about 1.5 times, more preferably at least about 1.8 times, and even more preferably at least about 2 times the phosphoglycerate mutase expression of corn after the same growth time that was exposed to the same stress and grown under the same conditions but without the treatment. Gene expression comparisons are determined as described in Example 4. (An upper limit of about 5 times or about 10 times can be used with any of the foregoing phosphoglycerate mutase expression ranges.)

When soybeans are exposed to a stress during growing and those soybeans are treated with a formulation of the present disclosure, about 24 hours after treatment that soybean expression of peroxygenase 2 is less than about 50%, preferably less than about 40%, and more preferably less than about 25%, the peroxygenase 2 expression of soybeans after the same growth time that was exposed to the same stress and grown under the same conditions but without the treatment described herein. (A lower limit of about 0% or about 1% can be used with any of the foregoing peroxygenase 2 expression ranges.)

As noted above, plants treated according to the present disclosure are also able to retain a large fraction of normal gene expression as the same type of plant grown without exposure to the stress. When corn is exposed to a stress during growing and that corn is treated with a formulation of the present disclosure, about 24 hours after treatment that corn's expression of phosphoglycerate mutase is at least about 50%, preferably at least about 70%, and more preferably at least about 80% of the phosphoglycerate mutase expression of corn after the same growth time under the same growth conditions but without exposure to the stress and without the disclosed treatment. (An upper limit of about 100% or about 125% can be used with any of the foregoing phosphoglycerate mutase retention ranges.)

When soybeans are exposed to a stress during growing and those soybeans are treated with a formulation of the present disclosure, about 24 hours after treatment the soybean expression of peroxygenase 2 is less than about 2.5 times, preferably less than about 2 times, more preferably less than about 1.6 times, and even more preferably less than about 1.3 times the peroxygenase 2 expression of soybeans after the same growth time under the same growth conditions but without exposure to the stress and without the treatment of this disclosure. (A lower limit of about 0 or about 0.1 can be used with any of the foregoing peroxygenase 2 expression ranges.)

Additional advantages of the various embodiments of the disclosure will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the disclosure. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

Further, all aspects and embodiments of the disclosure comprise, consist essentially of, or consist of any aspect or embodiment, or combination of aspects and embodiments disclosed herein.

### EXAMPLES

The following examples set forth methods in accordance with the disclosure. It is to be understood, however, that these examples are provided by way of illustration and nothing therein should be taken as a limitation upon the overall scope of the disclosure.

### Example 1

### Crop Growth and Treatment Protocol

### 1. Crop Growth

Seeds (corn or soybean) were planted in 1 kg pots that contained a 50-50 topsoil-sand mixture by weight. Liquid NPK (at a rate of 100-50-50 pounds/acre) was added to the media before planting and again two weeks after planting. The sources for the NPK were urea for nitrogen, monoammonium phosphate for phosphorous, and potassium sulfate for potassium. During growing, the average daytime temperature was about 78° F. (25.6° C.), and the average nighttime temperature was about 70° F. (21.1° C.). The crops received 100 mL of water per pot every other day until they reached V3 stage. Water was then withheld for 7-10 days (i.e., “drought conditions,” as used herein) for all plants except for one (the negative control, or “NoDrought”) in each round, at which point a comparative treatment (“Aminoacid,” or “Nutrients”), treatment according to this disclosure (“SMT”), or no treatment (“Drought” and “NoDrought”) was applied to all plants except for the negative control at a rate of 2 L/hectare. At 24 hours after treatment, samples were taken from each pot for purposes of the molecular marking testing described in Example 4 below. Each pot received 200 mL of water after the initial sample was taken, and the previous watering cycle resumed 2 days later (i.e., 100 mL per pot every other day) for 5 days. After 4 weeks of growth time, all plants were taken for chlorophyll (described in Example 2) and dry biomass (described in Example 3), except for one round of corn, which was grown for 2 months before being subjected to chlorophyll and dry biomass testing. Thus, for the corn grown for 2 months, the previous watering cycle was resumed for 35 days rather than only 5 days.

### 2. Treatment Protocol

In the following Examples, one embodiment of the formulation according to this disclosure was utilized, and it is referred to as “SMT.” Table 1 sets forth the SMT ingredients prior to diluting to 2% in water at time of treatment as described in Part 1 of this Example 1.

TABLE 1
SMT Formulation

| | % BY |
|---|---|
| INGREDIENT | WEIGHT* |
| Total Nitrogen | 2.5% |
| Molybdenum (source: sodium molybdate) | 5% |
| Phosphorus (source: monopotassium phosphate) | 3% |
| Zinc (source: Zinc EDTA) | 3% |
| Soluble Potash (source: K₂O) | 2.15% |
| Nickel (source: Nickel EDTA) | 0.75% |
| Sulfur (source: magnesium sulfate) | 0.72% |
| Magnesium (source: magnesium sulfate) | 0.5% |
| Cobalt (source: cobalt EDTA) | 0.25% |
| Glucose | 1.5% |
| Maltose | 0.125% |
| Stevioside | 0.075% |
| Citric Acid | 2.8% |
| Acetic Acid | 0.75% |
| Lactic Acid | 0.7% |
| L-Glutamic Acid | 2.01% |
| Phenylalanine | 0.155% |
| Serine | 0.206% |
| Methionine | 0.130% |
| Aspartic Acid | 0.118% |
| Tryptophan | 0.047% |
| Valine | 0.010% |
| Alanine | 0.007% |
| Glycine | 0.003% |
| Leucine | 0.002% |
| Isoleucine | 0.001% |
| Lysine | 0.001% |
| Water | 30% |
| Fat | 0.25% |
| Calcium | 0.1% |
| Sodium | 1.25% |
| Chloride | 4.5% |

*% by weight based on the weight of all ingredients in the formulation taken as 100% by weight. Table 1 does not include the percentages by weight of the portions of the nutrient sources that are not the nutrients (e.g., the weight of the EDTA portion of ZnEDTA is not represented in Table 1). The weights of those atoms would bring the sum of the percentages of Table 1 to 100%.

The “Nutrients” treatment as used in the following Examples is a blend of phosphate, zinc, molybdenum, magnesium, nickel, cobalt, potash, and sulfur.
The “Aminoacid” treatment as used in the following Examples is a blend of aspartic acid, serine, glycine, alanine, valine, methionine, isoleucine, leucine, phenylalanine, lysine, L-glutamic acid, tryptophan, glucose, maltose, acetic acid, citric acid, and lactic acid.

### Example 2

### Chlorophyll Analysis

### 1. Materials and Methods

In each instance, the total chlorophyll (i.e., both chlorophyll a and chlorophyll b) was determined in each test plant using the Arnon method. Five replicates were used for each treatment. For each replicate, 1 gram of fresh leaf tissue (from the youngest fully developed leaf) was used. Chlorophyll extractions were completed by cutting small pieces of leaves (˜1 cm² each piece) and placing it in 20 ml of 80% acetone. This mixture was shaken at high speed for one hour. After shaking, the mixture was centrifuged for 3 minutes at 4,000 RPM to pellet leaf debris tissue. Finally, the supernatant was used to get readings at 663 nm and 645 nm using a UV-Vis Spectrometer. The following Arnon equation was used to find the total amount of chlorophyll (in mg) per gram of leaf tissue.

$$\frac{20.2 ( {A}_{645} ) + 8.02 ( {A}_{663} )}{W} ,$$

where
A=absorbance at either 645 nm or 663 nm; and
W=weight of leaf sample (in this case, 1 g).

The foregoing was repeated for a second round of testing for each of corn and soybeans.

### 2. Corn Results

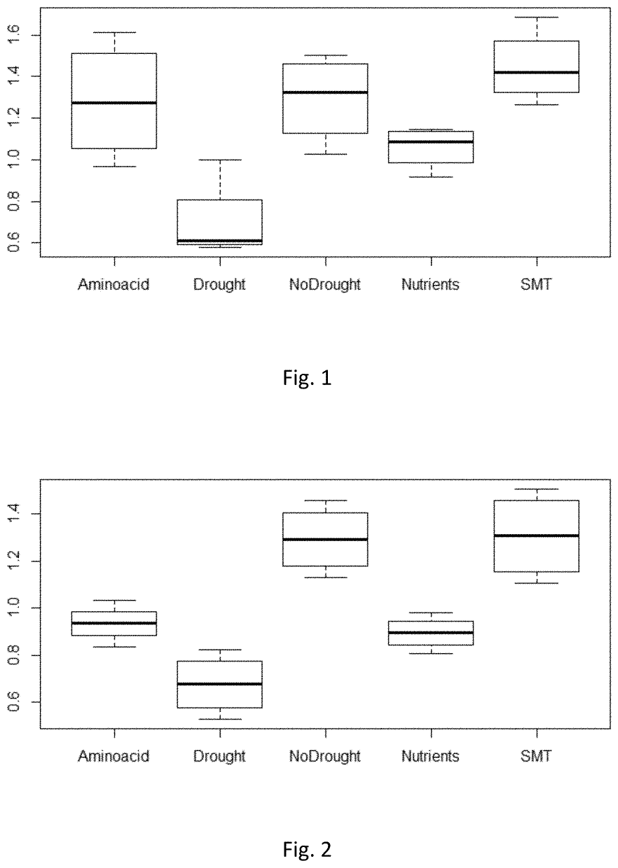

The detailed results for Rounds 1 (grown for 8 weeks) and 2 (grown for 4 weeks) of corn experiments are set forth in Tables 2-3, respectively, and are visually shown in FIGS. 1-2, respectively, where the y-axis shows the amount of chlorophyll (in mg per gram of tissue), and each bar on the x-axis shows the results for 5 tested treatments, with the bold horizontal line representing the median.

TABLE 2

| | | | | | | | | % D - NEG | % D - POS |
|---|---|---|---|---|---|---|---|---|---|
| TREATMENT | MEAN | SD | MIN | Q1 | MEDIAN | Q3 | MAX | CONTROL | CONTROL |
| Aminoacid | 1.283357 | 0.285025 | 0.96942 | 1.098221 | 1.2751671 | 1.460303 | 1.613672 | 83.49501334 | −0.886552428 |
| SMT | 1.448299 | 0.176969 | 1.264388 | 1.356041 | 1.4216661 | 1.513924 | 1.685474 | 107.0784945 | 11.85188703 |
| Drought | 0.699396 | 0.200167 | 0.579165 | 0.597677 | 0.6098228 | 0.711542 | 0.998774 | 0 | −45.98575418 |
| No Drought | 1.294836 | 0.212354 | 1.028998 | 1.175238 | 1.3245027 | 1.444101 | 1.501341 | 85.13634409 | 0 |
| Pulse | 1.060416 | 0.103946 | 0.917793 | 1.016823 | 1.0881291 | 1.131723 | 1.147615 | 51.61888996 | −18.10420007 |

TABLE 3

| | | | | | | | | % D - NEG | % D - POS |
|---|---|---|---|---|---|---|---|---|---|
| TREATMENT | MEAN | SD | MIN | Q1 | MEDIAN | Q3 | MAX | CONTROL | CONTROL |
| Aminoacid | 0.9349504 | 0.0802813 | 0.8366409 | 0.9091052 | 0.9349504 | 0.9607956 | 1.03326 | 38.08986331 | −27.707319 |
| Drought | 0.6770594 | 0.1269431 | 0.5291518 | 0.6041518 | 0.6770594 | 0.7499671 | 0.8249671 | 0 | −47.64809 |
| No Drought | 1.293285 | 0.14279 | 1.1301844 | 1.2051844 | 1.293285 | 1.3813856 | 1.4563856 | 91.01499809 | 0 |
| Nutrients | 0.8941437 | 0.072936 | 0.8055465 | 0.8634424 | 0.8941437 | 0.9248451 | 0.982741 | 32.06281458 | −30.862594 |
| SMT | 1.3060406 | 0.1827308 | 1.1058976 | 1.1808976 | 1.3060406 | 1.4311836 | 1.5061836 | 92.89896869 | 0.9862946 |

The results of Rounds 1 and 2 demonstrate that the disclosed formulation (“SMT”) assisted the plants in mitigating stress by continuing normal chlorophyll biosynthesis in the plant. This means that the plant can continue to carry out photosynthesis at normal levels, which increases the production of amino acids and proteins needed for normal plant development and growth. In both rounds of experiments, the SMT formulation under drought stress produced more chlorophyll than the “No Drought” treatment.

### 3. Soybean Results

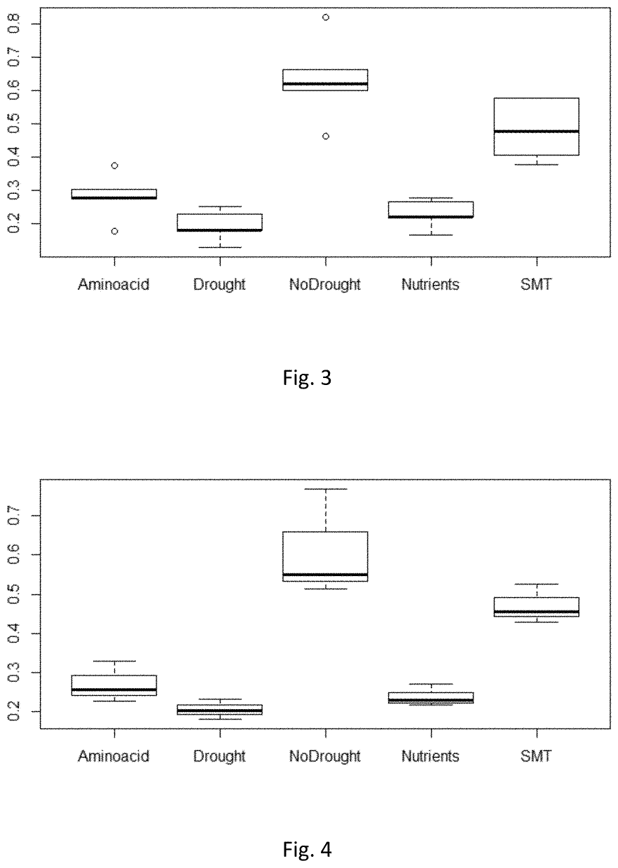

The detailed results for Rounds 1 and 2 (both grown 4 weeks) of the soybean experiments are set forth in Tables 4-5, respectively, and are visually shown in FIGS. 3-4, respectively. Again, in the figures, the y-axis shows the amount of chlorophyll (in mg per gram of tissue), and each bar on the x-axis shows the results for 5 tested treatments, with the bold horizontal line representing the median.

TABLE 4

| | | | | | | | | % D - NEG | % D - POS |
|---|---|---|---|---|---|---|---|---|---|
| TREATMENTS | MEAN | SD | MIN | Q1 | MEDIAN | Q3 | MAX | CONTROL | CONTROL |
| Aminoacid | 0.282483 | 0.07114 | 0.177891 | 0.276057 | 0.277891 | 0.304521 | 0.376057 | 44.7659 | −55.3893 |
| Drought | 0.195131 | 0.047521 | 0.130509 | 0.181356 | 0.181356 | 0.230509 | 0.251926 | 0 | −69.1842 |
| No Drought | 0.633218 | 0.12801 | 0.463782 | 0.600033 | 0.619248 | 0.663782 | 0.819248 | 224.5092 | 0 |
| Nutrients | 0.23081 | 0.044128 | 0.167621 | 0.220414 | 0.220414 | 0.267621 | 0.277979 | 18.28448 | −63.5497 |
| SMT | 0.482835 | 0.093207 | 0.376507 | 0.406177 | 0.478477 | 0.576507 | 0.576507 | 147.4412 | −23.7491 |

TABLE 5

| | | | | | | | | % D - NEG | % D - POS |
|---|---|---|---|---|---|---|---|---|---|
| TREATMENTS | MEAN | SD | MIN | Q1 | MEDIAN | Q3 | MAX | CONTROL | CONTROL |
| Aminoacid | 0.2694897 | 0.0525409 | 0.2260571 | 0.2402892 | 0.2545213 | 0.2912059 | 0.3278905 | 31.7173 | −55.895 |
| Drought | 0.204597 | 0.0255282 | 0.1805091 | 0.1912177 | 0.2019263 | 0.2166409 | 0.2313555 | 0 | −66.516 |
| No Drought | 0.6110208 | 0.138222 | 0.5137817 | 0.5319074 | 0.5500331 | 0.6596403 | 0.7692476 | 198.646 | 0 |
| Nutrients | 0.2386714 | 0.0279731 | 0.2176214 | 0.2228004 | 0.2279794 | 0.2491965 | 0.2704135 | 16.6544 | −60.939 |
| SMT | 0.4703868 | 0.0505361 | 0.4284767 | 0.4423269 | 0.456177 | 0.4913418 | 0.5265065 | 129.909 | −23.016 |

In line with the results forth corn testing, the results of Rounds 1 and 2 of the soybean testing demonstrated that the SMT formulation assisted the plants in mitigating stress by continuing normal chlorophyll biosynthesis in the plant. This means that the plant can continue photosynthesis at normal levels, which increases the production of amino acids and proteins needed for normal plant development and growth. In both rounds of soybean experiments, the SMT formulation under drought stress produced more chlorophyll than the “No Drought” treatment.

### Example 3

### Dry Biomass Determinations

### 1. Materials and Methods

Shoot and root tissue were collected from all plants. Roots were washed to remove all soil, and then the samples were dried at 200° F. (93.3° C.) for 48 hours, with the tissue for each replicate being dried individually in respective paper bags. The dried samples were then weighed, with their weights being recorded in grams.

### 2. Corn Results

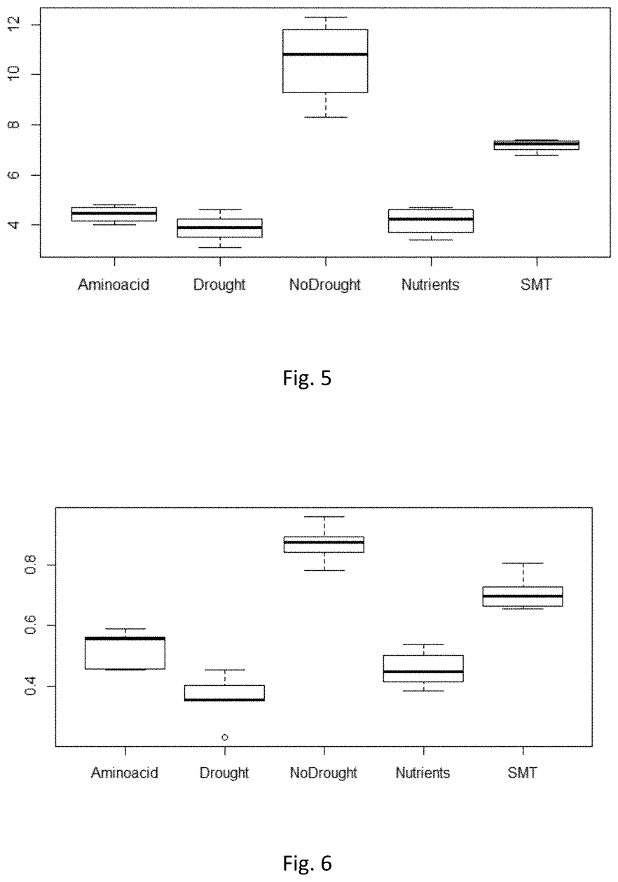

The detailed results for Rounds 1 (grown for 8 weeks) and 2 (grown for 4 weeks) of the corn experiments are set forth in Tables 6-7, respectively, and are visually shown in FIGS. 5-6, respectively, where the y-axis is the dry biomass in grams, and each bar on the x-axis shows the results for 5 tested treatments, with the bold horizontal line representing the median.

TABLE 6

| | | | | | | | | % D - NEG | % D - POS |
|---|---|---|---|---|---|---|---|---|---|
| TREATMENT | MEAN | SD | MIN | Q1 | MEDIAN | Q3 | MAX | CONTROL | CONTROL |
| Aminoacid | 4.425 | 0.35 | 4 | 4.225 | 4.45 | 4.65 | 4.8 | 14.19354839 | −58.05687204 |
| SMT | 7.175 | 0.262996 | 6.8 | 7.1 | 7.25 | 7.325 | 7.4 | 85.16129032 | −31.99052133 |
| Drought | 3.875 | 0.613053 | 3.1 | 3.7 | 3.9 | 4.075 | 4.6 | 0 | −63.27014218 |
| No Drought | 10.55 | 1.707825 | 8.3 | 9.8 | 10.8 | 11.55 | 12.3 | 172.2580645 | 0 |
| Pulse | 4.15 | 0.58023 | 3.4 | 3.85 | 4.25 | 4.55 | 4.7 | 7.096774194 | −60.66350711 |

TABLE 7

| | | | | | | | | % D - NEG | % D - POS |
|---|---|---|---|---|---|---|---|---|---|
| TREATMENTS | MEAN | SD | MIN | Q1 | MEDIAN | Q3 | MAX | CONTROL | CONTROL |
| Aminoacid | 0.5238 | 0.063448 | 0.453 | 0.458 | 0.557 | 0.563 | 0.588 | 46.3128 | −39.865 |
| Drought | 0.358 | 0.082565 | 0.231 | 0.35 | 0.353 | 0.403 | 0.453 | 0 | −58.9 |
| No Drought | 0.87104 | 0.065113 | 0.7832 | 0.843 | 0.875 | 0.894 | 0.96 | 143.307 | 0 |
| Nutrients | 0.4564 | 0.06326 | 0.383 | 0.413 | 0.447 | 0.501 | 0.538 | 27.486 | −47.603 |
| SMT | 0.7106 | 0.060604 | 0.656 | 0.664 | 0.699 | 0.728 | 0.806 | 98.4916 | −18.419 |

The results demonstrated that plants under drought stress that received the “SMT” treatments develop and grow more than plants that go through drought stress and receive other treatments or no treatment.

### 3. Soybean Results

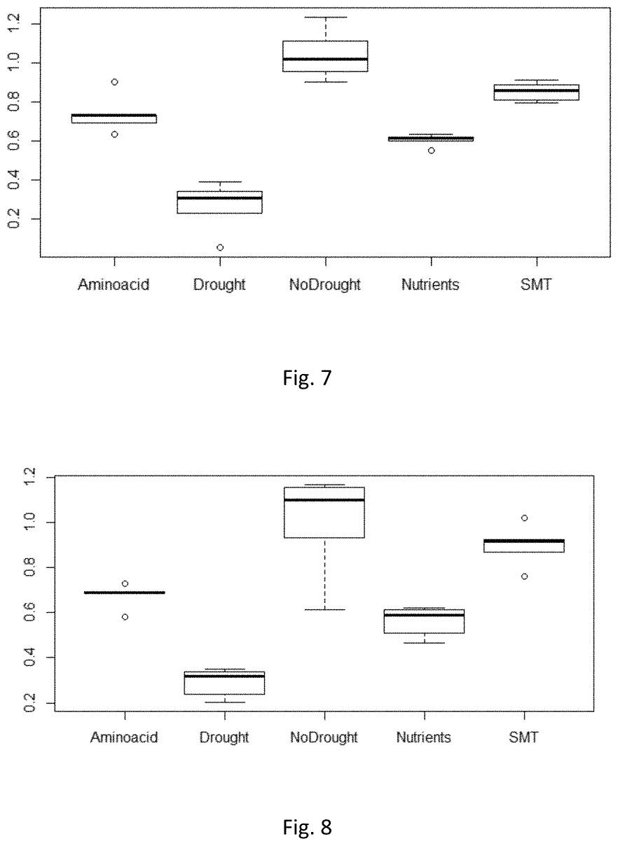

The detailed results for Rounds 1 and 2 (both grown for 4 weeks) of the soybean biomass experiments are set forth in Tables 8-9, respectively, and are visually shown in FIGS. 7-8, respectively, where the y-axis is the dry biomass in grams, and each bar on the x-axis shows the results for 5 tested treatments, with the bold horizontal line representing the median.

TABLE 8

| | | | | | | | | % D - NEG | % D - POS |
|---|---|---|---|---|---|---|---|---|---|
| TREATMENT | MEAN | SD | MIN | Q1 | MEDIAN | Q3 | MAX | CONTROL | CONTROL |
| Aminoacid | 0.7388 | 0.100567 | 0.632 | 0.694 | 0.732 | 0.733 | 0.903 | 177.536 | −29.193 |
| Drought | 0.2662 | 0.131319 | 0.056 | 0.231 | 0.309 | 0.343 | 0.392 | 0 | −74.487 |
| No Drought | 1.0434 | 0.13118 | 0.902 | 0.954 | 1.019 | 1.109 | 1.233 | 291.961 | 0 |
| Nutrients | 0.6046 | 0.031722 | 0.553 | 0.599 | 0.615 | 0.62 | 0.636 | 127.122 | −42.055 |
| SMT | 0.8518 | 0.049464 | 0.793 | 0.811 | 0.858 | 0.887 | 0.91 | 219.985 | −18.363 |

TABLE 9

| | | | | | | | | % D - NEG | % D - POS |
|---|---|---|---|---|---|---|---|---|---|
| TREATMENT | MEAN | SD | MIN | Q1 | MEDIAN | Q3 | MAX | CONTROL | CONTROL |
| Aminoacid | 0.6752 | 0.054733 | 0.582 | 0.684 | 0.69 | 0.693 | 0.727 | 133.4716 | −32.0451 |
| Drought | 0.2892 | 0.064577 | 0.203 | 0.239 | 0.317 | 0.338 | 0.349 | 0 | −70.8937 |
| No Drought | 0.9936 | 0.233197 | 0.612 | 0.932 | 1.1 | 1.156 | 1.168 | 243.5685 | 0 |
| Nutrients | 0.5598 | 0.06933 | 0.465 | 0.509 | 0.589 | 0.614 | 0.622 | 93.56846 | −43.6594 |
| SMT | 0.8978 | 0.094277 | 0.761 | 0.868 | 0.916 | 0.924 | 1.02 | 210.4426 | −9.64171 |

As was the case with the corn results above, these soybean results demonstrated that plants under drought stress that received the “SMT” treatments develop and grow more than plants that go through drought stress and receive other treatments or no treatment.

### Example 4

### Molecular Markers

### 1. Corn

Molecularly, the phosphoglycerate mutase enzyme (gene) was targeted. (Pan et al., 2016 https://www.ncbi.nlm.nih.gov/pmc/articles/PMC4842912/) This enzyme is part of the glycolysis pathway that converts glucose to pyruvate to produce energy (NADH and ATP). The under-expression of this enzyme (Relative Quantification or “RQ” values less than 1) indicates that glycolysis is reduced in treatments, which means the plant is not growing normally due to stress conditions.

### 2. Soybeans

Molecularly, the peroxygenase 2 enzyme (gene) was targeted. (Neves-Borges et al., 2012 https://www.ncbi.nlm.nih.gov/pmc/articles/PMC3392874/) This enzyme is activated by different biotic and abiotic stresses. The over-expression of this enzyme (RQ values more than 1) indicate that plants are undergoing higher stress, which means the plant is not growing normally due to the stress conditions.

### 3. Materials and Methods

The molecular experiment was repeated two times for each crop (corn and soybean). Two RNA samples were extracted from each replicate for each treatment (for each crop) using the RNEasy PowerPlant Kit (available from Qiagen), following the manufacturer's directions. For both crops, actin was used as the housekeeping gene for carrying out the gene expression analysis (2\hat{ }[−ΔΔCt]).

Next, qPCR was done using the ABI Step One Plus equipment in 20 microliter reactions following this method:
1. 50° C. for 10 minutes;
2. 95° C. for 2 minutes; and
3. 40 cycles of:
   a. 95° C. for 10 seconds; and
   b. 55° C. for 1 minute.

Each reaction tube had a final volume of 20 microliters containing:
10 microliters of qScript XLT One-Step RT-qPCR ToughMix ROX;
0.9 microliters of forward primer (450 nanomolar final concentration, 10 micromolar stock solution);
0.9 microliters of reverse primer (450 nanomolar final concentration, 10 micromolar stock solution);
0.24 microliters of probe (120 nanomolar final concentration, 10 micromolar stock solution);
5.96 microliters of molecular grade water; and
2 microliters of RNA.

The sequences of primers and probes are shown in Table 10.

TABLE 10

| | | | PROBE (FAM |
|---|---|---|---|
| SEQUENCES | | | FLUOROPHORE, 2 |
| (5′-3′ ORDER) | FORWARD | REVERSE | QUENCHERS) |
| Corn - Actin | ATGTTCGAGA | CGAAGAATAG | 56- |
| | CATTCAACTG | CATGAGGAAG | FAM/TTGTGCTCG/ZEN/ |
| | C | C | ACTCTGGTGATGG/3IABkFQ |
| | (SEQ ID NO: 1) | (SEQ ID NO: 5) | (SEQ ID NO: 9) |
| Corn - | TGCGAAAGCA | | 56- |
| Biphosphoglycerate | CTAGAGTATG | CTTGGAAGCTT | FAM/CCGATATGC/ZEN/ |
| mutase | C | CAACTCACC | TGGGATGCTTCAG/3IABkFQ |
| | (SEQ ID NO: 2) | (SEQ ID NO: 6) | (SEQ ID NO: 10) |
| Soybean - Actin | AGCTATGAGT | TGTATGTTGTC | 56- |
| | TGCCTGATGG | TCGTGAATGC | FAM/CAGGTCATC/ZEN/ |
| | (SEQ ID NO: 3) | (SEQ ID NO: 7) | ACCATTGGCGATG/3IABkFQ |
| | | | (SEQ ID NO: 11) |
| Soybean - | ATGAAGCTAT | TCACATTCTCC | 56- |
| Peroxygenase 2 | GGCTACAGTG | GTGTCAGG | FAM/CCAACAAGG/ZEN/ |
| | G | (SEQ ID NO: 8) | CACCAATCACTTCTG/ |
| | (SEQ ID NO: 4) | | 3IABkFQ |
| | | | (SEQ ID NO: 12) |

### 4. Results

a. Corn

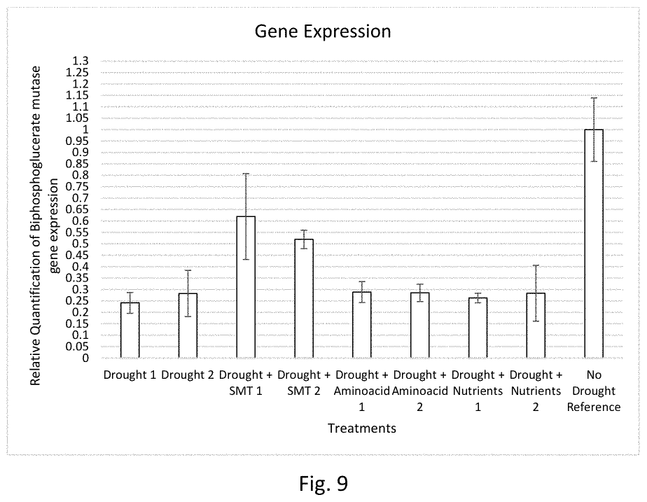

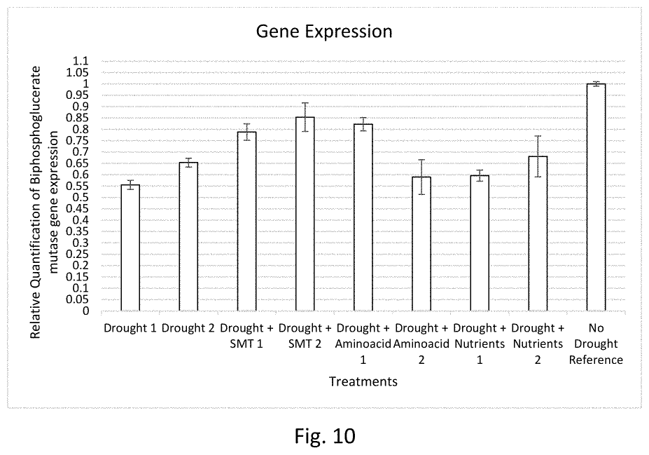

FIGS. 9 and 10 show the results for the two rounds of corn plants that were tested for expression of phosphoglycerate mutase. In each figure, the “No Drought” sample is set at an RQ value of 1, and the goal is for the treatment to be as close to 1 as possible as this shows the treatment is assisting the plant in behaving more closely to its behavior in a drought-free environment. Values lower than 1 are indicative of some amount of under-expression of this gene. As can be seen in the figures, the corn plants that were under drought stress and received the SMT treatment did not under-express the gene to the same degree as the plants that were under drought stress and received a different treatment or no treatment.

b. Soybeans

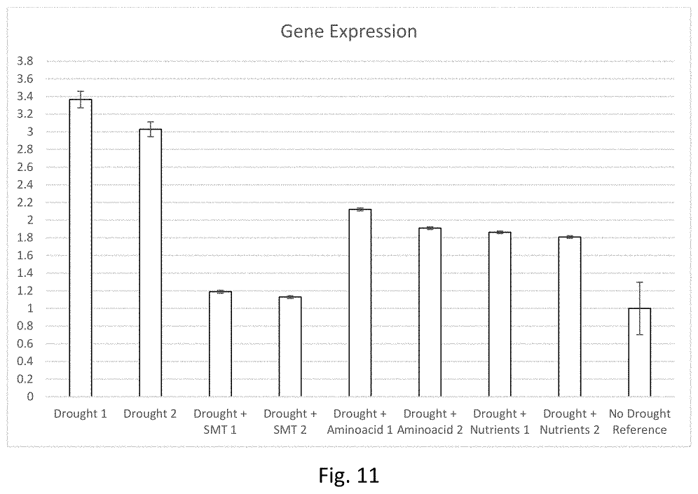

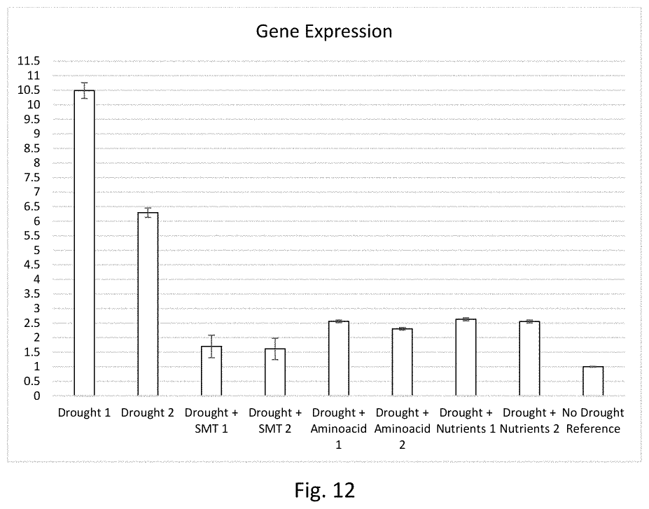

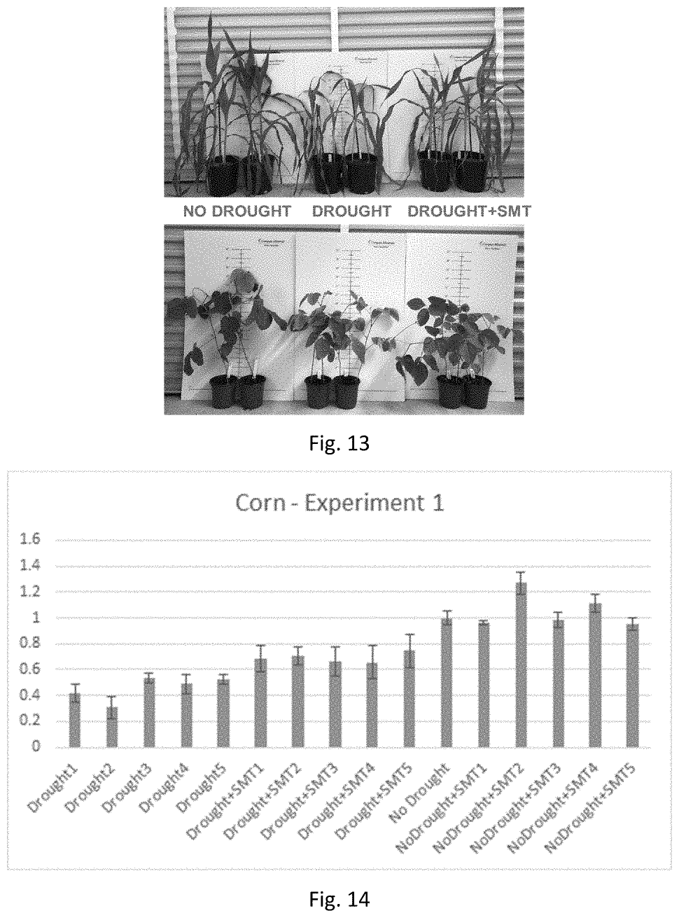

FIGS. 11 and 12 show the results for the two rounds of soybean plants that were tested for expression of peroxygenase 2. In each figure, the “No Drought” sample is set at an RQ value of 1, and the goal is for the treatment to be as close to 1 as possible as this shows the treatment is assisting the plant in behaving more closely to its behavior in a drought-free environment. Values greater than 1 indicate that overexpression is taking place. As can be seen in the figures, the soybean plants that were under drought stress and received the SMT treatment did not overexpress the gene as much as the plants that were under drought stress and received a different treatment or no treatment.

### Example 5

### Additional Crop Growth Data

Additional seeds (corn or soybean) were planted following the protocol described in Example 1. In this Example, the experiment was repeated two times for each crop, using ten replicates for each treatment in a greenhouse. Water was withheld for 10 days to create drought conditions (“drought” in the tables and graphs) in all plants except for in the negative control, “NoDrought,” and “NoDrought+SMT” plants, at which point the treatment according to the disclosure (“SMT”), or no treatment (“Drought” and “NoDrought”) was applied at a rate of 2 L/hectare, similar to as described in Example 1.

### 1. Dry Biomass

Dry biomass was determined as described in Example 3. Tables 11 and 12 show these results, with Table 12 being the results of those plants that were grown for two months. FIG. 5 shows the difference in plant growth at two months of growth for the plants grown under drought stress when treated according to present disclosure as compared to the “NoDrought” and “Drought” plants.

TABLE 11

| Corn - | | | | Soy - | | | |
|---|---|---|---|---|---|---|---|
| Experiment 1 | Treatment | mean | sd | Experiment 1 | Treatment | mean | sd |
| 1 | Drought | 0.714 | 0.321 | 1 | Drought | 0.675 | 0.132 |
| 2 | Drought + SMT | 1.777 | 0.136 | 2 | Drought + SMT | 1.156 | 0.311 |
| 3 | NoDrought | 2.023 | 0.342 | 3 | NoDrought | 1.532 | 0.274 |
| 4 | NoDrought + SMT | 2.275 | 0.286 | 4 | NoDrought + SMT | 1.663 | 0.286 |
| Corn - | | | | Soy - | | | |
| Experiment 2 | Treatment | mean | sd | Experiment 2 | Treatment | mean | sd |
| 1 | Drought | 0.683 | 0.165 | 1 | Drought | 0.453 | 0.327 |
| 2 | Drought + SMT | 1.265 | 0.254 | 2 | Drought + SMT | 0.701 | 0.197 |
| 3 | NoDrought | 1.830 | 0.249 | 3 | NoDrought | 1.286 | 0.187 |
| 4 | NoDrought + SMT | 1.794 | 0.274 | 4 | NoDrought + SMT | 1.198 | 0.102 |

TABLE 12

| | Treatment | mean | sd |
|---|---|---|---|
| Corn - Experiment 3 | | | |
| 1 | Drought | 6.728 | 0.492 |
| 2 | Drought + SMT | 9.932 | 0.553 |
| 3 | NoDrought | 13.293 | 0.642 |
| Soy - Experiment 3 | | | |
| 1 | Drought | 4.417 | 0.324 |
| 2 | Drought + SMT | 6.285 | 0.427 |
| 3 | NoDrought | 8.325 | 0.397 |

### 2. Chlorophyll Analysis

Chlorophyll was determined following the procedure described in Example 2. Those results (mg per gram of tissue) are shown in Table 13 and 14, with Table 14 being the results of those plants that were grown for two months.

TABLE 13

| Corn - | | | | Soy - | | | |
|---|---|---|---|---|---|---|---|
| Experiment 1 | Treatment | mean | sd | Experiment 1 | Treatment | mean | sd |
| 1 | Drought | 0.766 | 0.215 | 1 | Drought | 0.657 | 0.109 |
| 2 | Drought + SMT | 1.163 | 0.153 | 2 | Drought + SMT | 1.125 | 0.289 |
| 3 | NoDrought | 1.528 | 0.071 | 3 | NoDrought | 1.311 | 0.189 |
| 4 | NoDrought + SMT | 1.785 | 0.203 | 4 | NoDrought + SMT | 1.415 | 0.099 |
| Corn - | | | | Soy - | | | |
| Experiment 2 | Treatment | mean | sd | Experiment 2 | Treatment | mean | sd |
| 1 | Drought | 0.678 | 0.167 | 1 | Drought | 0.577 | 0.119 |
| 2 | Drought + SMT | 1.248 | 0.108 | 2 | Drought + SMT | 0.935 | 0.212 |
| 3 | NoDrought | 1.537 | 0.055 | 3 | NoDrought | 1.179 | 0.111 |
| 4 | NoDrought + SMT | 1.478 | 0.114 | 4 | NoDrought + SMT | 1.279 | 0.067 |

TABLE 14

| | Treatment | mean | sd |
|---|---|---|---|
| Corn - Experiment 3 | | | |
| 1 | Drought | 1.175 | 0.167 |
| 2 | Drought + SMT | 1.282 | 0.284 |
| 3 | NoDrought | 1.191 | 0.088 |
| Soy - Experiment 3 | | | |
| 1 | Drought | 1.082 | 0.195 |
| 2 | Drought + SMT | 1.191 | 0.026 |
| 3 | NoDrought | 1.239 | 0.177 |

### 3. Molecular Markers

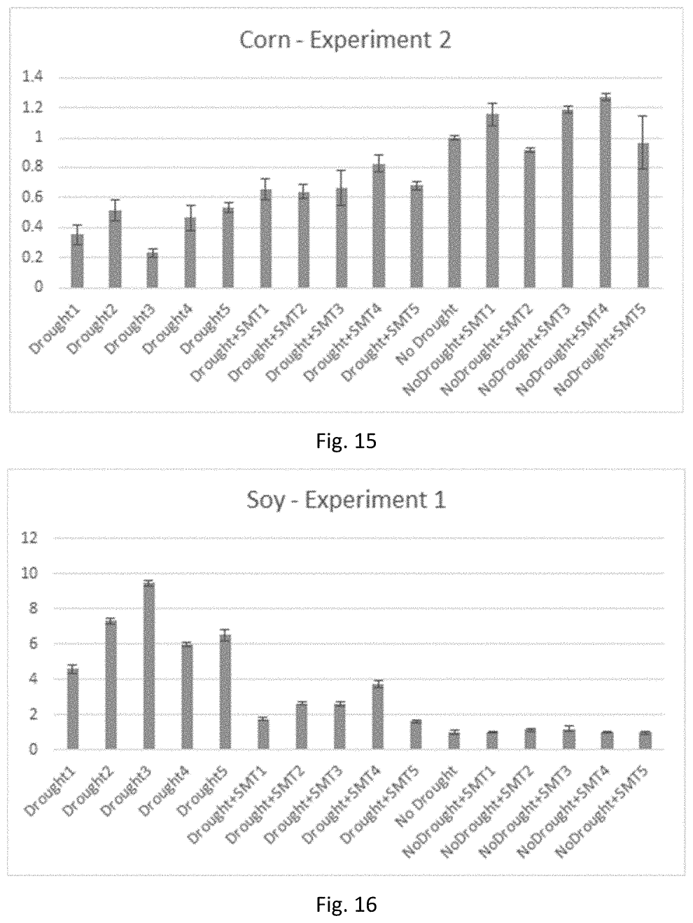

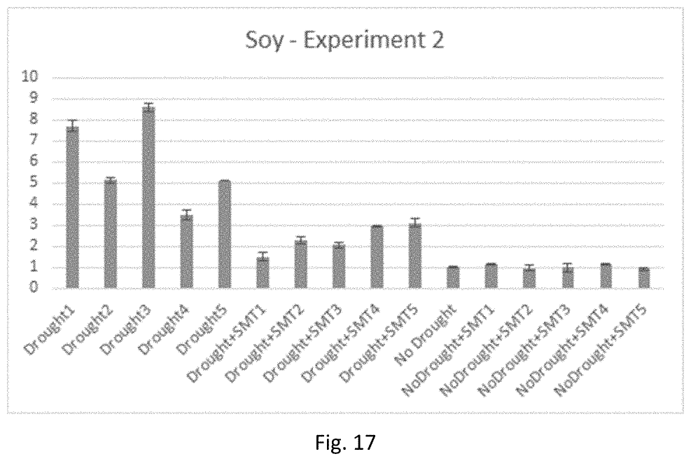

Gene expression was analyzed following the procedure of Example 4. The corn results are shown in Table 15 and FIGS. 14 and 15, while the soybean results are shown in Table 16 and FIGS. 16 and 17.

TABLE 15

| | | Relative Quantification | | SE | |
|---|---|---|---|---|---|
| Corn | | Experiment | Experiment | Experiment | Experiment |
| Treatments | Samples | 1 | 2 | 1 | 2 |
| Drought | 1 | 0.422552912 | 0.351545841 | 0.070488232 | 0.063385769 |
| | 2 | 0.306346056 | 0.516874626 | 0.085484322 | 0.071241208 |
| | 3 | 0.535804051 | 0.230933625 | 0.041696371 | 0.027835527 |
| | 4 | 0.488379444 | 0.466410629 | 0.074507581 | 0.083632909 |
| | 5 | 0.521413458 | 0.534304659 | 0.038502204 | 0.035057821 |
| Drought + SMT | 1 | 0.685004698 | 0.651674403 | 0.101870697 | 0.070499114 |
| | 2 | 0.709995774 | 0.640336493 | 0.069041525 | 0.043973318 |
| | 3 | 0.664782971 | 0.661546192 | 0.114774593 | 0.116187293 |
| | 4 | 0.657385162 | 0.825800546 | 0.126578415 | 0.054460764 |
| | 5 | 0.744747136 | 0.679211979 | 0.127901899 | 0.025465106 |
| NoDrought | 1 | 1 | 1 | 0.055718058 | 0.014830576 |
| NoDrought + | 1 | 0.963739161 | 1.155627367 | 0.015262723 | 0.073226509 |
| SMT | 2 | 1.268311615 | 0.955484312 | 0.086815928 | 0.017554575 |
| | 3 | 0.986975 | 1.190763844 | 0.056734429 | 0.022658546 |
| | 4 | 1.113024158 | 1.274859825 | 0.068804172 | 0.022100213 |
| | 5 | 0.954553854 | 0.965968766 | 0.048755086 | 0.178928524 |

TABLE 16

| | | Relative Quantification | | SE | |
|---|---|---|---|---|---|
| Soy | | Experiment | Experiment | Experiment | Experiment |
| Treatments | Samples | 1 | 2 | 1 | 2 |
| Drought | 1 | 4.583031601 | 7.722005732 | 0.236950583 | 0.252632612 |
| | 2 | 7.29470646 | 5.141052035 | 0.125980164 | 0.139311174 |
| | 3 | 9.467457193 | 8.611636947 | 0.186761317 | 0.188947084 |
| | 4 | 5.969689889 | 3.474737295 | 0.126218761 | 0.232309699 |
| | 5 | 6.503956561 | 5.107581706 | 0.327742442 | 0.012585786 |
| Drought + SMT | 1 | 1.74815659 | 1.491249903 | 0.096754449 | 0.212372367 |
| | 2 | 2.624257649 | 2.276899873 | 0.080575324 | 0.161518563 |
| | 3 | 2.609580268 | 2.063086867 | 0.110162855 | 0.14129511 |
| | 4 | 3.747503311 | 2.9597061 | 0.215784795 | 0.051226208 |
| | 5 | 1.604756738 | 3.109564519 | 0.116612471 | 0.17413697 |
| NoDrought | 1 | 1 | 1 | 0.092391819 | 0.034066886 |
| NoDrought + | 1 | 0.998083217 | 1.141069071 | 0.017902148 | 0.059455395 |
| SMT | 2 | 1.132993013 | 0.976755022 | 0.092034518 | 0.129303252 |
| | 3 | 1.198663465 | 0.990314813 | 0.128325964 | 0.196750064 |
| | 4 | 0.987964248 | 1.144707715 | 0.043944139 | 0.048946938 |
| | 5 | 0.968860409 | 0.912187958 | 0.090259998 | 0.054699325 |

Overall, all of the foregoing data shows that formulations according to the present disclosure consistently reduce drought stress compared to the negative control and the other two controls tested, which is a significant advantage for growers.

We claim:

1. A nutrient composition comprising:
respective sources of each of cobalt, nickel, zinc, and phosphorus; and
L-glutamic acid.

2. The composition of claim 1, further comprising an amino acid selected from the group consisting of aspartic acid, serine, glycine, alanine, valine, methionine, isoleucine, leucine, phenylalanine, lysine, tryptophan, and mixtures of the foregoing.

3. The composition of claim 2, wherein said composition comprises each of the following amino acids: aspartic acid, serine, glycine, alanine, valine, methionine, isoleucine, leucine, phenylalanine, lysine, and tryptophan.

4. The composition of claim 1, wherein said composition further comprises tryptophan.

5. The composition of claim 1, further comprising a nutrient selected from the group consisting of molybdenum, magnesium, manganese, iron, boron, sulfur, calcium, potassium, nitrogen, chloride, copper, selenium, sodium, and mixtures of the foregoing.

6. The composition of claim 1, further comprising a nutrient selected from the group consisting of molybdenum, magnesium, and both of molybdenum and magnesium.

7. The composition of claim 1, wherein L-glutamic acid is present in said composition at a level of from about 0.1% to about 10% by weight, based upon the total weight of the composition taken as 100% by weight.

8. The composition of claim 1, wherein each of said respective sources is individually selected from the group consisting of sulfates, oxides, chlorides, carbonates, phosphates, nitrates, and chelates of said respective source.

9. The composition of claim 5, wherein said nutrient is provided in a form selected from the group consisting of sulfates, oxides, chlorides, carbonates, phosphates, nitrates, and chelates of said nutrient.

10. The composition of claim 1, further comprising an ingredient selected from the group consisting of dispersing agents, anti-caking agents, dyes, flow agents, acids, sugars, and mixtures of the foregoing.

11. The composition of claim 1, wherein said composition is in liquid form.

12. The composition of claim 11, wherein said composition is in the form of an aqueous solution or dispersion.

13. The composition of claim 1, wherein said composition includes a quantity of amino acids, and at least about 75% by weight of said quantity is L-glutamic acid.

14. The composition of claim 1, wherein said composition includes a quantity of amino acids, and at least about 0.35% by weight of said quantity is tryptophan.

15. The composition of claim 1, wherein said composition includes a quantity of amino acids, and from about 0.35% by weight to about 1% by weight of said quantity is tryptophan and from about 75% by weight to about 99% by weight of said quantity is L-glutamic acid.

16. The composition of claim 1, wherein said composition further includes stevioside.

17. The composition of claim 1, wherein said composition further comprises the following:
from about 1% to about 6% by weight zinc;
from about 2% to about 8% by weight molybdenum;
from about 1.5% to about 5% by weight potassium;
from about 2.8% to about 6% by weight phosphorus; and
from about 1% to about 10% by weight nitrogen.

18. A method of using a nutrient composition comprising contacting a nutrient composition according to claim 1 with a plant and/or soil in which said plant is planted or will be planted.

19. The method of claim 18, wherein said plant is selected from the group consisting of corn, soybeans, rice, wheat, potato, sweet potato, citrus, common beans, tomato, and other horticultural crops.

20. The method of claim 18, wherein said plant is exposed to a stress during growing and wherein after about 4 weeks of growth, said plant has a chlorophyll content that is at least about 60% of the chlorophyll content of the same type of plant after about 4 weeks of growth under the same conditions but without said contacting and without said exposure.

21. The method of claim 18, wherein said plant is exposed to a stress during growing and wherein after about 4 weeks of growth, said plant has a chlorophyll content that is at least about 1.5 times the chlorophyll content of the same type of plant after about 4 weeks of growth under the same conditions and also exposed to said stress but without said contacting.

22. The method of claim 18, wherein said plant is exposed to a stress during growing and wherein after about 4 weeks of growth, said plant has a dry biomass that is at least about 60% of the dry biomass of the same type of plant after about 4 weeks of growth under the same conditions but without said contacting and without said exposure.

23. The method of claim 18, wherein said plant is exposed to a stress during growing and wherein after about 4 weeks of growth, said plant has a dry biomass that is at least about 1.5 times the dry biomass of the same type of plant after about 4 weeks of growth under the same conditions and also exposed to said stress but without said contacting.

24. The method of claim 18, wherein said plant is corn that is exposed to a stress during growing and about 24 hours after said contacting said corn's expression of phosphoglycerate mutase is at least about 40% of the phosphoglycerate expression of corn grown for the same time and under the same conditions but without said contacting and without said exposure.

25. The method of claim 18, wherein said plant is corn that is exposed to a stress during growing and about 24 hours after said contacting said corn's expression of phosphoglycerate mutase is at least about 1.2 times the phosphoglycerate expression of corn grown for the same time and under the same conditions and exposed to the same stress but without said contacting.

26. The method of claim 18, wherein said plant is soybean that is exposed to a stress during growing and about 24 hours after said contacting said soybean expression of peroxygenase 2 is less than about 50% of the peroxygenase 2 expression of soybeans grown for the same time and under the same conditions and exposed to said stress and grown under the same conditions but without said contacting.

27. The method of claim 18, wherein said plant is soybean that is exposed to a stress during growing and about 24 hours after said contacting, said soybean expression of peroxygenase 2 is less than about 2 times the peroxygenase 2 expression of soybeans grown for the same time and under the same conditions but without said contacting and without said exposure.

28. A plant with a nutrient composition according to claim 1 in contact with said plant.

29. The plant of claim 28, wherein said composition is in contact with a leaf of the plant.

30. The plant of claim 28, wherein said plant is selected from the group consisting of corn, soybeans, rice, wheat, potato, sweet potato, citrus, common beans, tomato, and other horticultural crops.

31. The combination of soil and a nutrient composition according to claim 1 in contact with said soil.


SEQUENCE LISTING (12 sequences)

SEQ ID NO: 1 - DNA, 21 bp, Artificial Sequence
  Synthetic Primer
atgttcgagacattcaactgc

SEQ ID NO: 2 - DNA, 21 bp, Artificial Sequence
  Synthetic Primer
tgcgaaagcactagagtatgc

SEQ ID NO: 3 - DNA, 20 bp, Artificial Sequence
  Synthetic Primer
agctatgagttgcctgatgg

SEQ ID NO: 4 - DNA, 21 bp, Artificial Sequence
  Synthetic Primer
atgaagctatggctacagtgg

SEQ ID NO: 5 - DNA, 21 bp, Artificial Sequence
  Synthetic Primer
cgaagaatagcatgaggaagc

SEQ ID NO: 6 - DNA, 20 bp, Artificial Sequence
  Synthetic Primer
cttggaagcttcaactcacc

SEQ ID NO: 7 - DNA, 21 bp, Artificial Sequence
  Synthetic Primer
tgtatgttgtctcgtgaatgc

SEQ ID NO: 8 - DNA, 19 bp, Artificial Sequence
  Synthetic Primer
tcacattctccgtgtcagg

SEQ ID NO: 9 - DNA, 22 bp, Artificial Sequence
  Synthetic Probe
  misc_feature (1)..(1): 56-FAM
  misc_feature (9)..(10): ZEN Quencher
  misc_feature (22)..(22): 3IABkFQ Quencher
ttgtgctcgactctggtgatgg

SEQ ID NO: 10 - DNA, 22 bp, Artificial Sequence
  Synthetic Probe
  misc_feature (1)..(1): 56-FAM
  misc_feature (9)..(10): ZEN Quencher
  misc_feature (22)..(22): 3IABkFQ Quencher
ccgatatgctgggatgcttcag

SEQ ID NO: 11 - DNA, 22 bp, Artificial Sequence
  Synthetic Probe
  misc_feature (1)..(1): 56-FAM
  misc_feature (9)..(10): ZEN Quencher
  misc_feature (22)..(22): 3IABkFQ Quencher
caggtcatcaccattggcgatg

SEQ ID NO: 12 - DNA, 24 bp, Artificial Sequence
  Synthetic Probe
  misc_feature (1)..(1): 56-FAM
  misc_feature (9)..(10): ZEN Quencher
  misc_feature (24)..(24): 3IABkFQ Quencher
ccaacaaggcaccaatcacttctg